(19) United States
(12) Patent Application Publication
(10) Pub. No.: US 2024/0362504 A1
(43) Pub. Date: Oct. 31, 2024

(54) DEVICE AND METHOD FOR PREDICTING EXHAUST EMISSIONS ON BASIS OF DATA ANALYSIS

(71) Applicant: DOOSAN ENERBILITY CO., LTD., Changwon (KR)

(72) Inventors: June Sung SEO, Gimpo (KR); Jung Min LEE, Seoul (KR); Gung Hul PARK, Seoul (KR); Hyun Su KANG, Suwon (KR)

(21) Appl. No.: 18/610,365

(22) Filed: Mar. 20, 2024

(30) Foreign Application Priority Data
Apr. 26, 2023 (KR) 10-2023-0054896

(51) Int. Cl. G06N 5/022; G06N 20/00

(52) U.S. Cl. CPC G06N 5/022; G06N 20/00

(57) ABSTRACT

A device and method for predicting exhaust emissions on the basis of data analysis is proposed. The method includes collecting, by a collection unit, raw data in real time from a power generation facility comprising a gas turbine, extracting, by a prediction unit, analysis data from the raw data, and predicting, by the prediction unit, the exhaust emissions to be emitted from the power generation facility a pre-derived delay time after the collecting of the raw data by analyzing the analysis data using a prediction model trained by learning.

### CROSS REFERENCE TO RELATED APPLICATION

The present application claims priority to Korean Patent Application No. 10-2023-0054896, filed Apr. 26, 2023, the entire contents of which are incorporated herein for all purposes by this reference.

### BACKGROUND OF THE INVENTION

### Field of the Invention

The present disclosure relates to technology for predicting exhaust emissions and, more particularly, to a device and method for predicting exhaust emissions on the basis of data analysis.

### Description of the Related Art

The amount of gas emitted from a gas turbine of a combined cycle power plant/cogeneration power plant is greatly affected by operating conditions and the environment. However, in traditional power plant systems, predicting harmful exhaust emissions can be challenging. Consequently, feedback control is implemented to take corrective action after assessing the actual amount of exhaust emissions. That is, conventional power plants often rely on operational methods that lack a preemptive response solution for the reduction of exhaust emissions.

### SUMMARY OF THE INVENTION

In order to solve the above-described problem, an objective of the present disclosure is to provide a device and method for predicting exhaust emissions on the basis of data analysis.

According to a preferred exemplary embodiment of the present disclosure to achieve the above-described objective, there is provided a method of predicting exhaust emissions, the method including: collecting, by a collection unit, raw data in real time from a power generation facility comprising a gas turbine; extracting, by a prediction unit, analysis data from the raw data; and predicting, by the prediction unit, the exhaust emissions to be emitted from the power generation facility a pre-derived delay time after the collecting of the raw data by analyzing the analysis data using a prediction model trained by learning.

The method may further include: selecting, by a learning unit before the step of extracting, the analysis data from among the raw data according to correlations with the exhaust emissions; preparing, by the learning unit, a plurality of training data sets; generating, by the learning unit, a plurality of candidate prediction models for predicting the exhaust emissions from the power generation facility after different delay times through learning using the plurality of training data sets; and selecting, by the learning unit, a candidate prediction model, from among the plurality of candidate prediction models, having the highest prediction accuracy for the exhaust emissions as the prediction model.

The step of selecting as the prediction model may include: preparing, by the learning unit, a plurality of evaluation data sets respectively corresponding to the plurality of candidate prediction models; generating, by each of the plurality of candidate prediction models, a plurality of prediction data sets through a weighting operation for a plurality of analysis data sets of the corresponding evaluation data sets; calculating, by the learning unit, prediction accuracy of each of the plurality of candidate prediction models by using the plurality of generated prediction data sets and a plurality of target data sets representing actual measured exhaust emissions of the power generation facility after the delay times respectively corresponding to the plurality of candidate prediction models; and selecting, by the learning unit, the candidate prediction model, from among the plurality of candidate prediction models, having the highest prediction accuracy for the exhaust emissions as the prediction model.

In the step of selecting as the prediction model, the learning unit may calculate the prediction accuracy of the candidate prediction model according to Equation

$${R}^{2} = 1 - \frac{\sum {( {y}_{i} - {\hat{y}}_{l} )}^{2}}{\sum {( {y}_{i} - {\overline{y}}_{l} )}^{2}} ,$$

where R² is the prediction accuracy, yᵢ is target data, ŷₗ is prediction data, and y̅ₗ is an average of the target data. Each of the plurality of training data sets may include the analysis data and target data representing actual measured exhaust emissions in correspondence with the analysis data, and different training data sets among the plurality of training data sets may have the target data representing the exhaust emissions after the different delay times.

The generating of the plurality of candidate prediction models may include: inputting, by the learning unit, the analysis data from any one training data set into the candidate prediction model with incompleted learning; deriving, by each candidate prediction model, prediction data representing the exhaust emissions from the power generation facility after the delay times by performing a weighting operation for applying weights with incompleted learning on the analysis data; calculating, by the learning unit, a loss representing a difference between the prediction data and target data through a loss function; and performing, by the learning unit, optimization for modifying the weight of each candidate prediction model so as to minimize the loss.

The selecting of the analysis data may be performed by selecting a plurality of types of data, from among the raw data, whose correlations with the exhaust emissions are greater than or equal to a preset value.

The selecting of the analysis data may include: classifying the raw data into a plurality of groups according to correlations among the raw data; prioritizing the plurality of groups in order of highest correlation with the exhaust emissions; and determining a predetermined number of groups in the order, having highest correlation with the exhaust emissions, as the analysis data.

The predicting of the exhaust emissions may include predicting, by the prediction unit, the analysis data through a delay prediction model t prediction data representing the exhaust emissions of the power generation facility after the delay time during which a change in the analysis data affects a change in the exhaust emissions of the power generation facility.

The deriving of the exhaust emissions may include: inputting, by the prediction unit, the analysis data into the learned prediction model; and deriving, by the prediction model, prediction data representing the exhaust emissions of the power generation facility after the delay time by performing a weighting operation for applying weights with completed learning on the analysis data.

The deriving of the prediction data may include: calculating input node values, by one or more input nodes in an input layer of the prediction model, by performing a weighting operation on the analysis data; calculating hidden node values, by one or more hidden nodes in one or more hidden layers of the prediction model, by performing a weighting operation on the input node values; and generating the prediction data, by an output node in an output layer of the prediction model, by performing a weighting operation on the hidden node values.

The raw data may include at least one among temperature data which is data related to temperatures of a gas turbine, heat dissipation data which is data related to cooling of the gas turbine, and fuel data which is data related to gas injected into the gas turbine.

According to a preferred exemplary embodiment of the present disclosure to achieve the above-described objective, there is provided a device for predicting exhaust emissions, the device including: a collection unit configured to collect raw data in real time from a power generation facility comprising a gas turbine; and a prediction unit configured to extract analysis data from the raw data and predict the exhaust emissions to be emitted from the power generation facility a pre-derived delay time after the collecting of the raw data by analyzing the analysis data using a prediction model trained by learning.

The device may further include: a learning unit configured to select, before the step of extracting, the analysis data from among the raw data according to correlations with the exhaust emissions, prepare a plurality of training data sets, generate a plurality of candidate prediction models for predicting the exhaust emissions from the power generation facility after different delay times through learning using the plurality of training data sets, and select a candidate prediction model, among the plurality of candidate prediction models, having the highest prediction accuracy for the exhaust emissions as the prediction model.

The learning unit may prepare a plurality of evaluation data sets respectively corresponding to the plurality of candidate prediction models, cause each of the plurality of candidate prediction models to generate a plurality of prediction data sets through a weighting operation for a plurality of analysis data sets of the corresponding evaluation data sets, calculate prediction accuracy of each of the plurality of candidate prediction models by using the plurality of generated prediction data sets and a plurality of target data sets representing actual measured exhaust emissions of the power generation facility after the delay times respectively corresponding to the plurality of candidate prediction models, and select the candidate prediction model, among the plurality of candidate prediction models, having the highest prediction accuracy for the exhaust emissions as the prediction model.

The learning unit may calculate the prediction accuracy of the candidate prediction model according to Equation

$${R}^{2} = 1 - \frac{\sum {( {y}_{i} - {\hat{y}}_{l} )}^{2}}{\sum {( {y}_{i} - {\overline{y}}_{l} )}^{2}} ,$$

where R² is the prediction accuracy, yᵢ is target data, ŷₗ is prediction data, and y̅ₗ is an average of the target data. Each of the plurality of training data sets may include the analysis data and target data representing actual measured exhaust emissions in correspondence with the analysis data, and different training data sets among the plurality of training data sets may have the target data representing the exhaust emissions after the different delay times.

The learning unit may input the analysis data from any one training data set into the candidate prediction model with incompleted learning, cause each candidate prediction model to derive prediction data representing the exhaust emissions from the power generation facility after the delay times by performing a weighting operation for applying weights with incompleted learning on the analysis data, calculate a loss representing a difference between the prediction data and target data through a loss function, and perform optimization for modifying the weight of each candidate prediction model so as to minimize the loss.

The learning unit may derive a plurality of types of data, from among the raw data, whose correlations with the exhaust emissions are greater than or equal to a preset value.

The learning unit may classify the raw data into a plurality of groups according to correlations among the raw data, prioritize the plurality of groups in order of highest correlation with the exhaust emission, and determine a predetermined number of groups in the order, having highest correlation with the exhaust emissions, as the analysis data.

The prediction unit may predict the analysis data through a delay prediction model so as to predict prediction data representing the exhaust emissions of the power generation facility after the delay time during which a change in the analysis data affects a change in the exhaust emissions of the power generation facility.

The prediction unit may input the analysis data into the learned prediction model, and the prediction model may derive prediction data representing the exhaust emissions of the power generation facility after the delay time by performing a weighting operation for applying weights with completed learning on the analysis data.

The prediction model may include: an input layer where one or more input nodes calculates input node values, by performing a weighting operation on the analysis data; one or more hidden layers where one or more hidden nodes calculates hidden node values by performing a weighting operation on the input node values; and an output layer where an output node generates the prediction data by performing a weighting operation on the hidden node values.

The raw data may include at least one among temperature data which is data related to temperatures of a gas turbine, heat dissipation data which is data related to cooling of the gas turbine, and fuel data which is data related to gas injected into the gas turbine.

According to the present disclosure, exhaust emissions after a delay time may be predicted through a learned prediction model EM, whereby preemptive measures may be taken to reduce exhaust emissions.

### BRIEF DESCRIPTION OF THE DRAWINGS

FIG. 1 is a view illustrating a configuration of a device for predicting exhaust emissions on the basis of data analysis according to an exemplary embodiment of the present disclosure.

FIGS. 2 and 3 are views illustrating a prediction model for predicting exhaust emissions on the basis of data analysis according to the exemplary embodiment of the present disclosure.

FIG. 4 is a flowchart illustrating a method of generating the prediction model for predicting the exhaust emissions on the basis of the data analysis according to the exemplary embodiment of the present disclosure.

FIG. 5 is a flowchart illustrating a method of generating a candidate prediction model through learning using a training data set according to the exemplary embodiment of the present disclosure.

FIG. 6 is a flowchart illustrating a method of selecting a prediction model from a plurality of candidate prediction models according to the exemplary embodiment of the present disclosure.

FIG. 7 is a flowchart illustrating a method of predicting exhaust emissions on the basis of data analysis according to the exemplary embodiment of the present disclosure.

FIG. 8 is a view illustrating a computing device according to the exemplary embodiment of the present disclosure.

### DETAILED DESCRIPTION OF THE INVENTION

The present disclosure may be modified in various ways and may have various exemplary embodiments, and thus specific exemplary embodiments will be exemplified and described in detail in the detailed description. However, this is not intended to limit the present disclosure to a particular disclosed form. On the contrary, the present disclosure is to be understood to include all various transformations, equivalents, and substitutes that may be included within the idea and technical scope of the present disclosure.

The terminology used in the present disclosure is for the purpose of describing particular exemplary embodiments only and is not intended to be limiting. As used herein, the singular forms are intended to include the plural forms as well, unless the context clearly indicates otherwise. In addition, it will be further understood that the terms “comprise”, “include”, “have”, etc. when used in the present disclosure, specify the presence of stated features, integers, steps, operations, elements, components, and/or combinations thereof but do not preclude the possibility of the presence or addition of one or more other features, integers, steps, operations, elements, components, and/or combinations thereof.

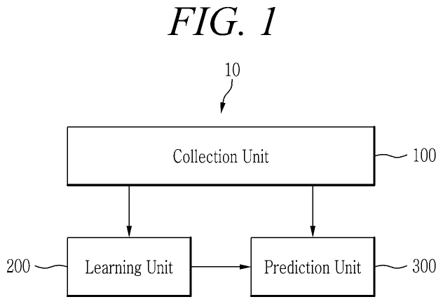

First, a device for predicting exhaust emissions on the basis of data analysis according to an exemplary embodiment of the present disclosure will be described. FIG. 1 is a view illustrating a configuration of the device for predicting the exhaust emissions on the basis of the data analysis according to the exemplary embodiment of the present disclosure.

Referring to FIG. 1, the device 10 (hereinafter referred to as the “prediction device”) for predicting exhaust emissions on the basis of data analysis according to the exemplary embodiment of the present disclosure includes a collection unit 100, a learning unit 200, and a prediction unit 300. The prediction device 10 may further include a network interface and input/output interface.

The collection unit 100 serves to collect raw data from a power generation facility, which incorporates a gas turbine. Here, the raw data includes control signals for controlling the power generation facility including the gas turbine and data collected from sensors and the like mounted on the power generation facility including the gas turbine. In particular, the raw data includes at least one among temperature data which is data related to temperatures of a gas turbine, heat dissipation data which is data related to cooling of the gas turbine, and fuel data (e.g., composition, concentration, amount, input rate) which is data related to gas injected into the gas turbine. The collection unit 100 may receive the raw data via the network interface or via the input/output interface.

The network interface may include any types of wired or wireless interwork interfaces that allows an electronic communication between the prediction device and other device. The input/output interface may include any types of interfaces that allows the prediction device to receive from a user an input information or provide to a user information of the prediction device such as, keyboard, mouse, touch screen, display, and audio/visual device.

The learning unit 200 is for generating a prediction model EM according to the exemplary embodiment of the present disclosure. The learning unit 200 generates a plurality of candidate prediction models EM and selects a candidate prediction model EM having the highest prediction accuracy among the plurality of candidate prediction models EM as a final prediction model EM.

The prediction unit 300 extracts analysis data that is part of the raw data collected by the collection unit 100, analyzes the analysis data using the prediction model EM generated by the learning unit 200, and predicts exhaust emissions from a power generation facility including a gas turbine after a certain delay time based on a time point at which the analysis data was collected (i.e., a time point at which the raw data was collected).

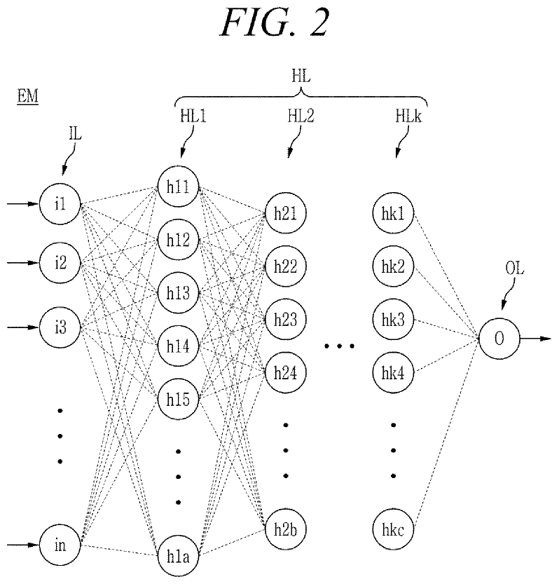

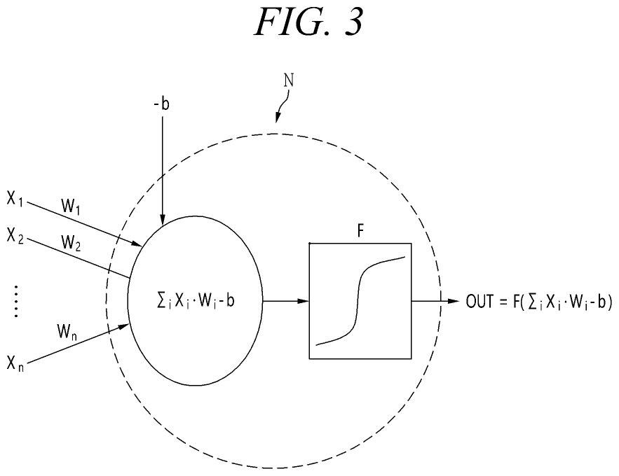

Next, a prediction model for predicting exhaust emissions on the basis of data analysis according to the exemplary embodiment of the present disclosure will be described. FIGS. 2 and 3 are views illustrating the prediction model for predicting the exhaust emissions on the basis of the data analysis according to the exemplary embodiment of the present disclosure.

Referring to FIGS. 2 and 3, the prediction model EM may be a learning model (i.e., a deep learning model/machine learning model) generated through learning (i.e., deep learning/machine learning). An example of the predictive model EM is shown in FIG. 2. According to the exemplary embodiment, the prediction model EM may be a multilayer perceptron (MLP) among deep neural networks. The prediction model EM includes a plurality of layers IL, HL, and OL. Specifically, the prediction model EM includes an input layer IL, one or more hidden layers HL (i.e., HL1 to HLk), and an output layer OL.

Each of the plurality of layers includes a plurality of operations. In addition, the plurality of layers is connected to each other by using weights W. In other words, operation result of any one layer is applied with a weight and input to a next layer. That is, in the prediction model EM, each layer receives input in a form of a value with an applied weight from the previous layer. It then performs an operation on this value and transmits a result operation output to the next layer as input. Examples of such an operation may include an operation using an activation function, etc. Such an operation will be referred to as “a weighting operation”. Examples of the activation function may include a signum function, a sigmoid, a hyperbolic tangent (tanh), an exponential linear unit (ELU), a rectified linear unit (ReLU), a leaky ReLU, Maxout, Minout, and Softmax.

Specifically, each of the plurality of layers IL, HL, and OL includes one or more nodes. For example, as shown in FIG. 2, the input layer IL may include n input nodes i1 to in, and the output layer OL may include one output node o. In addition, among the hidden layers HL, a first hidden layer HL1 may include “a” nodes h11 to h1a, a second hidden layer HL2 may include “b” nodes h21 to h2b, and a k-th hidden layer HLk may include “c” nodes hk1 to hkc. The number “a”, “b”, and “c” may be a natural number.

Each node in the plurality of layers IL, HL, and OL has its own operation. In particular, nodes in different layers are connected to each other by channels (indicated by dotted lines in FIG. 2.) having certain weights W. In other words, an operation result of any one layer is applied with a weight and input to the next layer.

Meanwhile, a node N according to the exemplary embodiment of the present disclosure is shown in FIG. 3. This exemplary node N may be applied to all nodes (i.e., i1 to in, h11 to h1a, h21 to h2b, hk1 to hkc, and o) in the prediction model EM.

In the node N, assuming that the previous layer has n nodes (“n” being a natural number), weights W=[W1, W2, . . . , Wn] are applied to input signals X=[X1, X2, . . . , Xn], and then applied results are taken by a function F. Here, the function F is an activation function. It should be noted that, even in a case of applying a same input (i.e., X1, X2, . . . , Xn being same input), an output may have a different value depending on a weight W. That is, the output y of each node is expressed in Equation 1 below:

$$y = F ( \sum {X}_{n} \cdot {W}_{n} - b ) \qquad [ Equation 1 ]$$

where, among parameters not yet described, b is a threshold. Such a threshold serves to prevent a corresponding node from being activated when a value in Equation 1 is less than the threshold. For example, the number of nodes in the previous layer of node N is assumed to be three. Accordingly, for the corresponding node N, there exist three inputs (n=3) X1, X2, and X3 and three weights W1, W2, and W3. The node N receives input of values obtained by respectively multiplying the three inputs X1, X2, and X3 by the corresponding weights W1, W2, and W3, adds up all the values, subtract the threshold b from the sum to get a summed/subtracted value, input a summed/subtracted value into an activation function, and then calculates an output. Specifically, it is assumed that the inputs are “[X1, X2, X3]=[0.5, −0.3, 0]”, and the weights are “[W1, W2, W3]=[4, 5, 2]”. In addition, for convenience of description, when assumed that the activation function is a signum function and the threshold b is zero (0), then the output is calculated as follows.

$$\begin{matrix}X 1 \times W 1 = 0.5 \times 4 = 2 \\ X 2 \times W 2 = - 0.3 \times 5 = - 1.5 \\ X 3 \times W 3 = 0 \times 2 = 0 \\ 2 + ( - 1.5 ) + 0 = 0.5 \\ sgn ( 0.5 ) = 1\end{matrix}$$

According to an embodiment, the threshold b may be set as zero (0) and the subtraction of the threshold step may be omitted.

In this way, in the prediction model EM of this disclosure, every node receives input of values obtained by applying weights to outputs from each node of the previous layer. The node then adds the values, performs an operation according to an activation function, and transmits this operation result as an input to the next layer. In other words, any one node in any one layer of the prediction model EM receives input of values obtained by applying weights to input from nodes in the previous layer, adds the values, applies an activation function, and transmits this result as input to the next layer. According to an embodiment, depending on the value of the threshold b, the node may be deactivated. When the node is inactivated, the output of the node may be null or a value zero (0).

Here, for the nodes in the input layer IL, the input signals X=[X1, X2, . . . , Xn] may indicate any value or information based on raw data collected by the collection unit 100. For example, the input signals X=[X1, X2, . . . , Xn] may include temperature data of the gas turbine, heat dissipation data of the gas turbine, fuel data of the gas injected in to the gas turbine.

Accordingly, the prediction unit 300 extracts the analysis data from the raw data received from the collection unit 100 and inputs the extracted analysis data into the prediction model EM, and then the prediction model EM generates prediction data. The prediction model EM generates the prediction data by performing a plurality of operations including applying weights of the plurality of layers IL, HL, and OL to the input analysis data. Such prediction data represents exhaust emissions (e.g., composition, amounts and concentration) after a certain delay time based on the time point at which the analysis data was 15 collected (i.e., the same time point when the raw data was collected).

To describe more specifically, in a case when the analysis data is input to a plurality of input nodes i1 to in of the input layer IL of the prediction model EM, each of the plurality of input nodes i1 to in calculates an input node value by performing an operation (i.e., a weighting operation) according to an activation function for the analysis data. Then, each of one or more hidden nodes in one or more hidden layers calculates a hidden node value by performing the weighting operation (e.g., the operation using the activation function) on each input node value. For example, each of a plurality of first hidden nodes h11 to h1a of a first hidden layer HL1 receives input of values (indicated by dotted lines in FIG. 2), which are obtained by applying respective weights to the input node values of the plurality of input nodes i1 to in, adds up all the input values, subtract the threshold b, and then performs an operation according to the activation function on the summed value, whereby a plurality of first hidden node values is calculated. Subsequently, each of a plurality of second hidden nodes h21 to h2b of a second hidden layer HL2 receives input of values (indicated by dotted lines in FIG. 2) which are obtained by applying respective weights to the plurality of first hidden node values of the plurality of first hidden nodes h11 to h1a, adds up all the input values, subtract the threshold b, and performs an operation according to the activation function on the summed value, whereby a plurality of second hidden node values is calculated. In such a way, previous node values with applied weights in the hidden layer HL are transmitted, and current node values are calculated through the operation. By repeating such a process, a plurality of k-th hidden node values of a plurality of k-th hidden nodes hk1 to hkc of a k-th hidden layer HLk may be calculated.

Accordingly, referring to FIG. 2, an output node o receives input of values (indicated by dotted lines) obtained by applying weights W=[W1, W2, . . . , Wc] to the plurality of k-th hidden node values of the plurality of k-th hidden nodes hk1 to hkc of the k-th hidden layer HLk, adds all the input values, subtract the threshold b, and then performs an operation according to the activation function on the summed value, thereby calculating an output value, i.e., prediction data. Here, the prediction data represents exhaust emissions (e.g., composition, amounts and concentration) after a delay time based on a time point when the input analysis data was collected (i.e., the same time point when the raw data was collected).

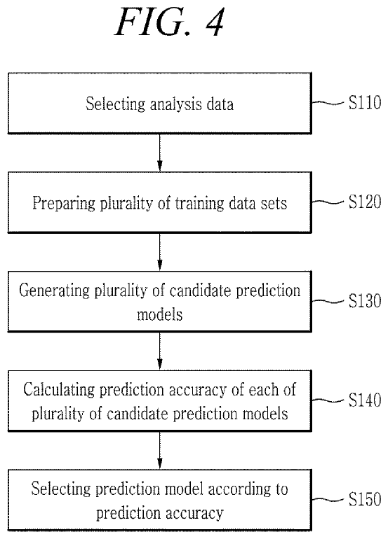

Next, a method of generating a prediction model for predicting exhaust emissions on the basis of data analysis according to the exemplary embodiment of the present disclosure will be described. FIG. 4 is a flowchart illustrating the method of generating the prediction model for predicting the exhaust emissions on the basis of the data analysis according to the exemplary embodiment of the present disclosure.

In step S110, a learning unit 200 selects at least some of raw data collected from a power generation facility including a gas turbine and determines the selected data as analysis data. Here, the raw data includes control signals for controlling the power generation facility including the gas turbine and data collected from sensors and the like mounted on the power generation facility including the gas turbine. In particular, the raw data includes at least one among temperature data which is data related to temperatures of the gas turbine, heat dissipation data which is data related to cooling of the gas turbine, and fuel data which is data related to gas injected into the gas turbine.

According to an embodiment, the learning unit 200 may select and determine the analysis data among the raw data according to correlations with the exhaust emissions through regression analysis.

For example, the learning unit 200 may identify a plurality of types of data, from the raw data, whose correlations with the exhaust emissions are greater than or equal to a preset threshold. These identified data may be used as analysis data.

For another example, the learning unit 200 may classify the raw data into a plurality of groups according to correlations among the raw data, and determine a predetermined number of groups of raw data from the plurality of classified groups as analysis data, in order of highest correlation (i.e., prioritized by their correlation) with the exhaust emissions.

For example, the learning unit 200 may determine, as a result of regression analysis, to include one type of data (e.g., temperature data of a gas turbine) in the analysis data while exclude another type of data in the raw data from the analysis data.

In step S120, the learning unit 200 prepares a plurality of training data sets by using the analysis data.

Specifically, any one training data set may include a plurality of pieces of analysis data, and target data corresponding to the plurality of pieces of analysis data. Here, the target data represents information on exhaust emissions actually measured after a predetermined delay time in correspondence with the analysis data. Here, the delay time refers to the time duration over which a change observed in the analysis data effectively influences a corresponding alteration (i.e., change) in the exhaust emissions of a power generation facility. For example, the alternation in exhaust emissions is not instantaneous upon a change in the amount of gas injected into a gas turbine (i.e., modification in analysis data) is changed. Rather, the changed amount of gas affects the exhaust emissions after a certain period of time has passed. That is, the delay time may be the time it takes for the analysis data to affect the exhaust emissions. According to the exemplary embodiment of the present disclosure, the delay time is based on a time point at which the target data corresponding to the analysis data was collected.

In particular, the target data of different training data sets may represent information on exhaust emissions actually measured after different delay times. For example, target data corresponding to a plurality of pieces of analysis data in a first training data set may represent exhaust emissions after a delay time of one minute, while target data corresponding to a plurality of pieces of analysis data in a second training data set may represent exhaust emissions after a delay time of 1 minute 30 seconds.

In step S130, the learning unit 200 generates a plurality of candidate prediction models through learning using a plurality of training data sets. Each of the plurality of candidate prediction models is trained by using different training data sets. Accordingly, each of the plurality of candidate prediction models predicts exhaust emissions from a power generation facility after different delay times. As such, a method of generating a candidate prediction model of the learning unit 200 will be described in more detail below.

In step S140, the learning unit 200 calculates prediction accuracy for exhaust emissions of each of a plurality of candidate prediction models. Because of predicting the exhaust emissions from a power generation facility after different delay times, the plurality of candidate prediction models may have different prediction accuracies. Accordingly, in step S150, the learning unit 200 selects a candidate prediction model with the highest prediction accuracy for exhaust emissions among the plurality of candidate prediction models as a final prediction model.

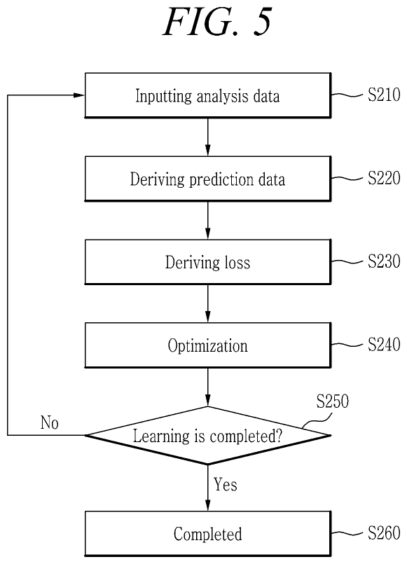

Next, a method of generating a candidate prediction model through learning using a training data set, which is performed in step S130, according to the exemplary embodiment of the present disclosure will be described more in detail. FIG. 5 is a flowchart illustrating the method of generating the candidate prediction model through the learning using the training data set according to the exemplary embodiment of the present disclosure. Specifically, FIG. 5 shows the method of generating one candidate prediction model through learning using any one training data set when the learning unit 200 generates the plurality of candidate prediction models through the learning using the plurality of training data sets in step S130 of FIG. 4.

Referring to FIG. 5, in step S210, the learning unit 200 inputs the analysis data from the training data set into a candidate prediction model EM with incompleted learning (i.e., a candidate prediction model EM that is still in the process of learning or has incomplete). The candidate prediction model EM has the same configuration to that of a prediction model EM that will be finally selected. In addition, as described above, the training data set used in the corresponding candidate prediction model EM includes a plurality of type of analysis data, and target data representing exhaust emissions actually measured in correspondence with the plurality of pieces of analysis data. In particular, the training data set used in the candidate prediction model EM has target data representing exhaust emissions after different delay times different from those of the training data set used in other candidate prediction models EM.

Next, in step S220, the candidate prediction model EM derives prediction data representing exhaust emissions of a power generation facility after a delay time by performing a weighting operation for applying weights with incompleted learning on the analysis data.

Then, in step S230, the learning unit 200 calculates a loss representing a difference between the prediction data and the target data through a loss function. According to the exemplary embodiment, the learning unit 200 may calculate the loss representing the difference between the prediction data and the target data through the loss function as shown in Equation 2 below.

$$L = \sqrt{\frac{1}{N} {\sum }_{i = 1}^{N} {( {y}_{i} - {\hat{y}}_{l} )}^{2}} \qquad [ Equation 2 ]$$

where L represents a loss. In addition, yᵢ indicates target data and ŷₗ indicates prediction data. In addition, i is an index corresponding to analysis data.

Next, in step S240, the learning unit 200 performs optimization, adjusting the weights of each candidate prediction model EM to minimizes the loss to the greatest extent possible. Algorithms such as gradient descent may be used as an example in the optimization.

Next, in step S250, the learning unit 200 checks whether a learning completion condition is satisfied or not. Here, the learning completion condition may be met under various circumstances, such as when a loss is below a preset threshold, a loss has converged, the number of learning iterations surpass a preset count, or precision, a learning rate, a recall rate, etc. are greater than or equal to their respective predetermined values. As a result of checking in step S250, in a case where the learning completion condition is not satisfied, the above-described steps S210 to S250 are repeatedly performed. In contrast, in a case where the learning completion condition is satisfied, in step S260, the learning unit 300 completes the learning of the candidate prediction model EM.

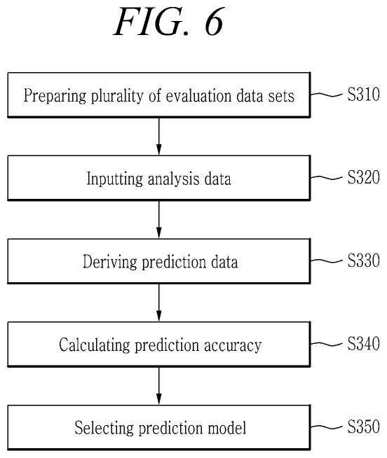

Next, a method of selecting any one of the plurality of candidate prediction models as a final prediction model according to the exemplary embodiment of the present disclosure will be described. FIG. 6 is a flowchart illustrating the method of selecting the final prediction model from the plurality of candidate prediction models according to the exemplary embodiment of the present disclosure. Specifically, illustrates steps S140 and S150 performed by the learning unit 200 in FIG. 4 in more detail. In FIG. 6, it is assumed that learning of the plurality of candidate prediction models EM has been completed in the same method as described in step S130 and FIG. 5 described above.

In step S310, the learning unit 200 prepares a plurality of evaluation data sets respectively corresponding to the plurality of candidate prediction models EM. Each of the plurality of evaluation data sets includes a plurality of pieces of analysis data and a plurality of pieces of target data representing exhaust emissions actually measured in correspondence with the plurality of pieces of analysis data. Among the plurality of evaluation data sets, different evaluation data sets may have target data representing exhaust emissions after different delay times corresponding to the candidate prediction models. That is, the different evaluation data sets may have the same plurality of pieces of analysis data, while having different target data representing the exhaust emissions measured after the different delay times. Such delay times are the same as the delay times of the training data sets used when learning the corresponding candidate prediction models EM.

Next, in step S320, the learning unit 200 inputs the plurality of pieces of analysis data from the evaluation data sets respectively corresponding to the plurality of candidate prediction models EM.

Then, in step S330, each of the plurality of candidate prediction models EM derives a plurality of pieces of prediction data through a weighting operation. This operation includes applying weights with completed learning on the plurality of pieces of analysis data of the corresponding evaluation data sets.

In step S340, the learning unit 200 calculates prediction accuracy of each of the plurality of candidate prediction models. In this case, the learning unit 200 calculates the prediction accuracy of each of the plurality of candidate prediction models by using the target data and the plurality of prediction data generated previously (in step S330). According to the exemplary embodiment, the learning unit 200 may calculate the prediction accuracy of each candidate prediction model EM according to Equation 3 below.

$${R}^{2} = 1 - \frac{\sum {( {y}_{i} - {\hat{y}}_{l} )}^{2}}{\sum {( {y}_{i} - {\overline{y}}_{l} )}^{2}} , \qquad [ Equation 3 ]$$

where R² represents prediction accuracy. In addition, yᵢ is target data, ŷₗ is prediction data generated by a corresponding candidate prediction model EM in correspondence with analysis data, and y̅ₗ represents an average of the target data. In addition, i represents an index of the target data.

Next, in step S350, the learning unit 200 finally selects a candidate prediction model EM having the highest prediction accuracy for the exhaust emissions among the plurality of candidate prediction models as a final prediction model EM according to the prediction accuracy calculated previously (in step S340).

According to an embodiment, from among various delay times, a delay time used for the final prediction model EM may be selected as the delay time to be used in predicting the exhaust emissions.

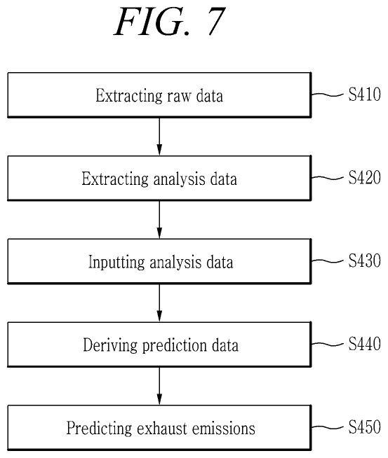

As described above, when the final prediction model EM is selected, the exhaust emissions is predicted by using the selected prediction model EM. Then, such a method will be described as follows. FIG. 7 is a flowchart illustrating the method of predicting exhaust emissions on the basis of data analysis according to the exemplary embodiment of the present disclosure.

Referring to FIG. 7, in step S410, the collection unit 100 collects raw data in real time from a power generation facility including a gas turbine.

Then, in step S420, from the raw data, the prediction unit 300 extracts the previously derived analysis data. As previously described in step S110, here, the raw data is control signals for controlling the power generation facility including the gas turbine or data collected from sensors and the like mounted on the power generation facility including the gas turbine. In particular, the raw data includes at least one among temperature data which is data related to temperatures of the gas turbine, heat dissipation data which is data related to cooling of the gas turbine, and fuel data which is data related to gas injected into the gas turbine. In particular, the analysis data is data selected and determined according to correlations with the exhaust emissions among the raw data.

Next, in step S430, the prediction unit 300 inputs the analysis data into the final prediction model EM. Then, in step S440, the prediction model EM performs a weighting operation for applying weights with completed learning on the analysis data so as to derive prediction data representing exhaust emissions of the power generation facility after a delay time. Here, as described through FIGS. 4 to 6, the delay time corresponds to the prediction model EM. As such, the method of generating the prediction data in step S440 will be described in more detail as follows.

One or more input nodes of the input layer IL of the prediction model EM perform weighting operations on the analysis data to calculate input node values. Thereafter, one or more hidden nodes in one or more hidden layers HL of the prediction model EM perform weighting operations on the input node values to calculate hidden node values. Next, an output node of an output layer OL of the prediction model EM performs a weighting operation on the hidden node values to generate prediction data.

As described above, when the prediction data is generated, in step S450, the prediction unit 300 predicts exhaust emissions after a delay time based on the time point at which the analysis data was collected according to the prediction data.

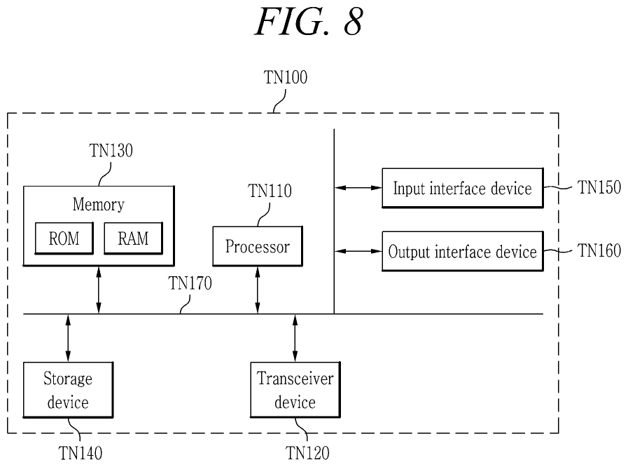

FIG. 8 is a view illustrating a computing device according to the exemplary embodiment of the present disclosure. The computing device TN100 in FIG. 8 may be a prediction device 10 described herein.

In the exemplary embodiment of FIG. 8, the computing device TN100 may include at least one processor TN110, a transmission/reception device TN120, and a memory TN130. In addition, the computing device TN100 may further include a storage device TN140, an input interface device TN150, an output interface device TN160, etc. Components included in the computing device TN100 and connected to each other by a bus TN170 may communicate with each other.

The processor TN110 may execute a program command stored in at least one among the memory TN130 and the storage device TN140. The processor TN110 may refer to a central processing unit (CPU), a graphics processing unit (GPU), semiconductor device, an integrated circuit or a dedicated processor on which methods according to the exemplary embodiments of the present disclosure are performed. The processor TN110 may be configured to implement procedures, functions, methods, and the like which are described in connection with the exemplary embodiments of the present disclosure. The processor TN110 may control each component of the computing device TN100.

Each of the memory TN130 and the storage device TN140 may store various information related to the operation of the processor TN110. Each of the memory TN130 and the storage device TN140 may be comprised of at least one of a volatile storage medium and a non-volatile storage medium. For example, the memory TN130 may be comprised of at least one of read only memory (ROM) and random access memory (RAM).

The collection unit 100, the learning unit 200, the prediction unit 300 may be implemented in separate hardware circuitries or in a combined circuitry, having the processor TN110 and the memory TN130, or may be implemented in software modules (i.e., program commands) that are stored in the memory TN130 and/or the storage device 140.

The transmission/reception device TN120 may transmit or receive wired signals or wireless signals. The transmission/reception device TN120 may be connected to a network and perform communication. The network interface of the prediction device 10 may be implemented in a form of the transmission/reception device TN120.

The input/output interface of the prediction device 10 may be implemented in a form of the input interface device TN150 and the output interface device TN160. The output interface device TN160 may provide the predicted exhaust emissions predicted by the prediction unit in a visual and/or audial form via a display and/or a speaker.

Meanwhile, various methods according to the exemplary embodiments of the present disclosure described above may be implemented in the form of programs readable through various computer means and be recorded on computer-readable recording media. Here, the recording media may store program commands, data files, data structures, etc., singly or in combination thereof. The program commands recorded on the recording media may be designed and configured specifically for the embodiments of the present disclosure or may be publicly known and available to those skilled in the art of computer software. For example, the recording media include: magnetic media such as hard disks, floppy disks, and magnetic tapes; optical media such as CD-ROMs and DVDs; magneto-optical media such as floptical disks; and a hardware device specially configured to store and execute program commands, the hardware device including such as ROM, RAM, flash memory, etc. Examples of the computer commands include not only machine language generated by a compiler, but also high-level language wires executable by a computer using an interpreter or the like. Such a hardware device described above may be configured to operate by using one or more software modules in order to perform the operation of the embodiments of the present disclosure, and vice versa.

Although the exemplary embodiments of the present disclosure have been described above, those skilled in the art will be able to modify and change the present disclosure in various ways by attaching, changing, deleting or adding components without departing from the spirit of the present disclosure as described in the patent claims, and this will also be included within the scope of rights of the present disclosure. Also, it is noted that any one feature of an embodiment of the present disclosure described in the specification may be applied to another embodiment of the present disclosure. Similarly, the present invention encompasses any embodiment that combines features of one embodiment and features of another embodiment.

What is claimed is:

1. A method of predicting exhaust emissions, the method comprising:
collecting, by a collection unit, raw data in real time from a power generation facility comprising a gas turbine;
extracting, by a prediction unit, analysis data from the raw data; and
predicting, by the prediction unit, the exhaust emissions to be emitted from the power generation facility a pre-derived delay time after the collecting of the raw data by analyzing the analysis data using a prediction model trained by learning.

2. The method of claim 1, further comprising:
selecting, by a learning unit before the step of extracting, the analysis data from among the raw data according to correlations with the exhaust emissions;
preparing, by the learning unit, a plurality of training data sets;
generating, by the learning unit, a plurality of candidate prediction models for predicting the exhaust emissions from the power generation facility after different delay times through learning using the plurality of training data sets; and
selecting, by the learning unit, a candidate prediction model, from among the plurality of candidate prediction models, having the highest prediction accuracy for the exhaust emissions as the prediction model.

3. The method of claim 2, wherein the step of selecting as the prediction model comprises:
preparing, by the learning unit, a plurality of evaluation data sets respectively corresponding to the plurality of candidate prediction models;
generating, by each of the plurality of candidate prediction models, a plurality of prediction data sets through a weighting operation for a plurality of analysis data sets of the corresponding evaluation data sets;
calculating, by the learning unit, prediction accuracy of each of the plurality of candidate prediction models by using the plurality of generated prediction data sets and a plurality of target data sets representing actual measured exhaust emissions of the power generation facility after the delay times respectively corresponding to the plurality of candidate prediction models; and
selecting, by the learning unit, the candidate prediction model, from among the plurality of candidate prediction models, having the highest prediction accuracy for the exhaust emissions as the prediction model.

4. The method of claim 2, wherein, in the step of selecting as the prediction model, the learning unit calculates the prediction accuracy of the candidate prediction model according to Equation
$${R}^{2} = 1 - \frac{\sum {( {y}_{i} - {\hat{y}}_{l} )}^{2}}{\sum {( {y}_{i} - {\overline{y}}_{l} )}^{2}} ,$$
where R² is the prediction accuracy,
yᵢ is target data,
ŷₗ is prediction data, and
y̅ₗ is an average of the target data.

5. The method of claim 2, wherein each of the plurality of training data sets comprises the analysis data and target data representing actual measured exhaust emissions in correspondence with the analysis data, and
different training data sets among the plurality of training data sets have the target data representing the exhaust emissions after the different delay times.

6. The method of claim 2, wherein the generating of the plurality of candidate prediction models comprises:
inputting, by the learning unit, the analysis data from any one training data set into the candidate prediction model with incompleted learning;
deriving, by each candidate prediction model, prediction data representing the exhaust emissions from the power generation facility after the delay times by performing a weighting operation for applying weights with incompleted learning on the analysis data;
calculating, by the learning unit, a loss representing a difference between the prediction data and target data through a loss function; and
performing, by the learning unit, optimization for modifying the weight of each candidate prediction model so as to minimize the loss.

7. The method of claim 2, wherein the selecting of the analysis data is performed by selecting a plurality of types of data, from among the raw data, whose correlations with the exhaust emissions are greater than or equal to a preset value.

8. The method of claim 2, wherein the selecting of the analysis data comprises:
classifying the raw data into a plurality of groups according to correlations among the raw data;
prioritizing the plurality of groups in order of highest correlation with the exhaust emissions; and
determining a predetermined number of groups in the order, having highest correlation with the exhaust emissions, as the analysis data.

9. The method of claim 1, wherein the predicting of the exhaust emissions comprises:
inputting, by the prediction unit, the analysis data into the learned prediction model; and
deriving, by the prediction model, prediction data representing the exhaust emissions of the power generation facility after the delay time during which a change in the analysis data affects a change in the exhaust emissions of the power generation facility by performing a weighting operation for applying weights with completed learning on the analysis data.

10. The method of claim 9, wherein the deriving of the prediction data comprises:
calculating input node values, by one or more input nodes in an input layer of the prediction model, by performing a weighting operation on the analysis data;
calculating hidden node values, by one or more hidden nodes in one or more hidden layers of the prediction model, by performing a weighting operation on the input node values; and
generating the prediction data, by an output node in an output layer of the prediction model, by performing a weighting operation on the hidden node values.

11. A device for predicting exhaust emissions, the device comprising:
a collection unit configured to collect raw data in real time from a power generation facility comprising a gas turbine; and
a prediction unit configured to extract analysis data from the raw data and predict the exhaust emissions to be emitted from the power generation facility a pre-derived delay time after the collecting of the raw data by analyzing the analysis data using a prediction model trained by learning.

12. The device of claim 11, further comprising:
a learning unit configured to
select, before the step of extracting, the analysis data from among the raw data according to correlations with the exhaust emissions,
prepare a plurality of training data sets,
generate a plurality of candidate prediction models for predicting the exhaust emissions from the power generation facility after different delay times through learning using the plurality of training data sets, and
select a candidate prediction model, among the plurality of candidate prediction models, having the highest prediction accuracy for the exhaust emissions as the prediction model.

13. The device of claim 12, wherein the learning unit further configured to
prepare a plurality of evaluation data sets respectively corresponding to the plurality of candidate prediction models,
cause each of the plurality of candidate prediction models to generate a plurality of prediction data sets through a weighting operation for a plurality of analysis data sets of the corresponding evaluation data sets,
calculates prediction accuracy of each of the plurality of candidate prediction models by using the plurality of generated prediction data sets and a plurality of target data sets representing actual measured exhaust emissions of the power generation facility after the delay times respectively corresponding to the plurality of candidate prediction models, and
selects the candidate prediction model, among the plurality of candidate prediction models, having the highest prediction accuracy for the exhaust emissions as the prediction model.

14. The device of claim 12, wherein the learning unit calculates the prediction accuracy of the candidate prediction model according to Equation
$${R}^{2} = 1 - \frac{\sum {( {y}_{i} - {\hat{y}}_{l} )}^{2}}{\sum {( {y}_{i} - {\overline{y}}_{l} )}^{2}} ,$$
where R² is the prediction accuracy,
yᵢ is target data,
ŷₗ is prediction data, and
y̅ₗ is an average of the target data.

15. The device of claim 12, wherein each of the plurality of training data sets comprises the analysis data and target data representing actual measured exhaust emissions in correspondence with the analysis data, and
different training data sets among the plurality of training data sets have the target data representing the exhaust emissions after the different delay times.

16. The device of claim 12, wherein the learning unit inputs the analysis data from any one training data set into the candidate prediction model with incompleted learning, causes each candidate prediction model to derive prediction data representing the exhaust emissions from the power generation facility after the delay times by performing a weighting operation for applying weights with incompleted learning on the analysis data, calculates a loss representing a difference between the prediction data and target data through a loss function, and performs optimization for modifying the weight of each candidate prediction model so as to minimize the loss.

17. The device of claim 12, wherein the learning unit derives a plurality of types of data, from among the raw data, whose correlations with the exhaust emissions are greater than or equal to a preset value.

18. The device of claim 12, wherein the learning unit further configured to
classifies the raw data into a plurality of groups according to correlations among the raw data,
prioritize the plurality of groups in order of highest correlation with the exhaust emission; and
determines a predetermined number of groups in the order, having highest correlation with the exhaust emissions, as the analysis data.

19. The device of claim 11, wherein the prediction unit inputs the analysis data into the learned prediction model, and
the prediction model derives prediction data representing the exhaust emissions of the power generation facility after the delay time during which a change in the analysis data affects a change in the exhaust emissions of the power generation facility by performing a weighting operation for applying weights with completed learning on the analysis data.

20. The device of claim 19, wherein the prediction model comprises:
an input layer where one or more input nodes calculates input node values, by performing a weighting operation on the analysis data;
one or more hidden layers where one or more hidden nodes calculates hidden node values by performing a weighting operation on the input node values; and
an output layer where an output node generates the prediction data by performing a weighting operation on the hidden node values.
